(19) United States
(12) Patent Application Publication
(10) Pub. No.: US 2007/0238819 A1
(43) Pub. Date: Oct. 11, 2007

(54) Curing Agent for Polyurethane Paint and Process for Producing the same

(76) Inventors: Shuso Iyoshi, Ohtake-shi (JP); Tatsumi Fujii, Ohtake-shi (JP)

Correspondence Address: BIRCH STEWART KOLASCH & BIRCH, PO BOX 747, FALLS CHURCH, VA, 22040-0747, US

(21) Appl. No.: 10/574,912

(22) PCT Filed: Oct. 7, 2004
(86) PCT No.: PCT/JP04/15204

§ 371 Date: Apr. 7, 2006

(30) Foreign Application Priority Data
Oct. 10, 2003 (JP) 2003-352791

(51) Int. Cl. C08G 18/42; C09D 175/10

(52) U.S. Cl. 524/354; 524/361

(57) ABSTRACT

The present invention relates to a process for producing a curing agent for a polyurethane paint, which comprises an aliphatic or alicyclic diisocyanate and a polyester polyol, wherein the polyester polyol is a copolymerized lactone polyol obtained by a ring-opening copolymerization of at least two members of cyclic lactone compounds each represented by the following formula (I) in the presence of a low molecular weight compound having at least two active hydrogen groups as an initiator. By using at least two members of cyclic lactone compounds, there is provided a curing agent for a polyurethane paint which is capable of forming a paint film having high mechanical strength, particularly high flexibility or impact resistance under low temperatures, and excellent in gloss retention.

### TECHNICAL FIELD

The present invention relates to a curing agent for a two-component polyurethane paint and a process for producing the same. In more detail, the present invention relates to a curing agent for a two-component polyurethane paint, which is applicable to a resin molded article for motor vehicles (e.g., a bumper) or a resin molded article for other than motor vehicles, or applicable to an outer (or exterior) material (or member) for buildings. The curing agent is formable of a cured paint film (coat or coating) having good extensibility, and particularly being excellent in mechanical properties under low temperatures; and a process for producing the same.

### BACKGROUND ART

In recent years, as typified by an automobile bumper, various resin molded articles instead of steel products are adopted as an automobile part (auto supply) in terms of safety improvement derived from shock absorption, further for the purpose of weight saving. In general, however, the resin molded article cannot avoid aging caused by outdoor exposure, that is, the resin molded article cannot escape from color change or deterioration in physical properties with ages. Therefore, a surface painting is required from the viewpoint of anti-aging, anti-damaging, and outer appearance. In such a case, it is a property required for a paint to resist to all of the environmental affects under automobile utilization. That is, there is a demand for a paint which is formable a cured paint film (coat or coating) having excellent weather resistance as well as various properties such as good flexibility, impact resistance, and adhesiveness to a resin molded article to be painted under low temperatures up to about −30° C., without deteriorating flexibility, impact restitution property, and rigidity of a subject to be painted.

Moreover, usage for an outer material for buildings also requires almost the same physical properties as the automotive parts because of sever outdoor exposure. As a paint satisfying such required physical properties, for example, there has been known a one-component printing polyurethane paint which is cured by crosslinking a terminal hydroxyl group-containing polyurethane resin with an aminoplast resin as disclosed in Japanese Patent No. 32568/1973 (JP-48-32568B) and others. However, the one-component printing polyurethane paint needs high baking temperature, and further the paint film formed from the above paint deteriorates in flexibility under low temperature. The above document also discloses an approach to lessen a curing temperature by adding an acid catalyst, but even in the case of adding the catalyst, it is necessary to bake the paint at a temperature of 110 to 120° C. for 30 minutes or over. Further, because of deterioration of storage stability of the paint, undesirable phenomena such as gelation sometimes occur.

Furthermore, Japanese Patent Application Laid-Open No.32662/1983 (JP-58-32662A) discloses a method for imparting elasticity to a cured paint film by adding a third component, that is, adding a polycaprolactone polyol having a hydroxyl group as a soft component to a two-component polyurethane paint used for repairing an outer steel sheet (or plate) for automobiles. This method does not need to separately prepare a paint for outer sheets and a paint for resinous parts upon repairing both an outer steel sheet for automobiles and a resinous part such as a bumper all at once. Further the method is conveniently conducted only by blending the third component in addition to a base resin and a curing agent in the paint for automobile outer sheets. However, in such a case, in order to adjust a paint to have an appropriate NCO/OH equivalent ratio, this method is troublesome for necessity of changing the ratio of the base resin relative to the curing agent depending on the added amount of the third component. Further, since the mistaken or incorrect blending amount largely affects physical properties of the obtained paint film, there causes a lot of working botheration such as strict management of the blending ratio of three components (the base resin, the curing agent, and the additive), and others.

Moreover, from the viewpoint of hardness required for the cured paint film formed from a paint used for repairing an automobile steel outer sheet, an acrylic resin having a relatively high glass transition temperature (Tg) is usually employed as abase resin. Further, as a curing agent, for example, there are used a buret adduct obtained from hexamethylene diisocyanate, a trimethylolpropane adduct, an isocyanurate product (body), and others. The commercially available product includes “DURANATE 24A-90CX” [(Trade Mark), manufactured by Asahi Kasei Corporation], “CORONATE HL” and “CORONATE EH” [(Trade Mark), both of them are manufactured by Nippon polyurethane Industry Co., Ltd.], and others.

These curing agents are a polyisocyanate having a high NCO content, and having a small distance between NCO groups within one molecule. Therefore, even in adding a soft component as the third component, rigid parts remain in the crosslinking structure of the cured paint film. As a result, demand for enlargement of the elasticity in the whole paint film requires adding a large amount of soft components, resulting in only obtaining a cured paint film which is insufficient in hardness or strength as well as deteriorates in weather resistance. Further, impurities such as water contained in the soft component added as the third component have some influence on the cured paint film, and cause a trouble such as lowering performance of the cured paint film.

Moreover, Japanese Patent No. 70120/1994 (JP-6-70120B) discloses a curing agent for paints obtained by reacting a straight or branched alkyl chain-containing polyester polyol having a molecular weight of 400 to 1500 with an excessive amount of a polyisocyanate compound, and removing the excess polyisocyanate compound after the reaction. However, the cured paint film formed from the paint obtained from the branched alkyl chain-containing polyester polyol has flexibility, whereas the cured paint film is deteriorated in mechanical properties, particularly wear resistance.

Further, Japanese Patent Application Laid-Open No. 28518/1986 (JP-61-28518A) discloses a technique to obtain a paint composition having extensibility and being excellent in flexibility under low temperatures, water resistance, and weather resistance. That is, the development is carried out for a urethane prepolymer obtained by combining an aliphatic diisocyanate or an alicyclic diisocyanate with a polycaprolactone diol or triol which is obtained from a single cyclic lactone compound and has a number average molecular weight of 500 to 1500. With the use of the above polycaprolactone diol or triol, the paint composition is obtained by blending two components without particularly adding a third component. In the paint composition, a conventional base resin for a metal paint comprising a polyurethane, or a similar kind of base resin comprising an acryl polyol having a relatively high glass transition temperature is used as it is.

However, in the case of preparing the curing agent for a polyurethane paint as disclosed in the JP-61-28518A with the use of the polycaprolactone diol or triol obtained from a single cyclic lactone compound, the obtained polyurethane curing agent becomes clouded or solidified because of high crystallinity of the polycaprolactone diol or triol. In particular, the bifunctional polycaprolactone having a molecular weight of not less than 500 crystallizes at ambient temperatures, further the trifunctional polycaprolactone having a molecular weight of more than 800 highly tends to crystallize.

The inventors of the present invention made intensive studies to achieve the above objects and finally found that the above problems is dissolved by using a curing agent for a polyurethane paint which is a prepolymer and comprises a copolymerized lactone polyol obtained from different cyclic lactone compounds of not less than two members and an aliphatic diisocyanate or alicyclic diisocyanate. The present invention was accomplished based on the above findings.

### DISCLOSURE OF THE INVENTION

That is, according to a first aspect of the present invention, there is provided a process for producing a curing agent for a polyurethane paint, which comprises allowing an aliphatic or alicyclic diisocyanate to react with a polyester polyol having at least two active hydrogen groups in a molecule thereof in an NCO/OH equivalent ratio of 5 to 20, and removing an unreacted aliphatic or alicyclic diisocyanate, wherein the polyester polyol is a blended (mixed) lactone polyol obtained by a ring-opening copolymerization of at least two members of cyclic lactone compounds each represented by the following formula (I) in the presence of (with the use of) a low molecular weight compound having at least two active hydrogen groups as an initiator

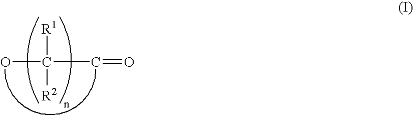

wherein R¹ and R² may be the same or different, each representing (n pieces of R¹ and R² are independently representing) a hydrogen atom or a C₁₋₄alkyl group, and 3≦n≦7.

Moreover, according to a second aspect of the present invention, there is provided a process described in the first aspect of the invention, in which the cyclic lactone compounds represented by the formula (I) comprise ε-caprolactone and δ-valerolactone, and the molar ratio of the ε-caprolactone relative to the δ-valerolactone is 80/20 to 20/80. Further, according to a third aspect of the present invention, there is provided a process described in the first or second aspect of the invention, in which the molecular weight of the copolymerized lactone polyol is 500 to 3000. Furthermore, according to a forth aspect of the present invention, there is provided a process described in any one of the first to third aspects of the invention, in which the initiator comprises at least one member selected from the group consisting of ethylene glycol, diethylene glycol, 1,4-butanediol, 1,5-pentanediol, 1,6-hexanediol, neopentyl glycol, glycerin, trimethylolpropane, triethanolamine, and pentaerythritol. In addition, according to a fifth aspect of the present invention, there is provided a curing agent for a polyurethane paint obtainable by a production process recited in the process described in any one of the first to forth aspects of the invention.

### BEST MODE FOR CARRYING OUT THE INVENTION

Hereinafter, the embodiment of the present invention is illustrated.

The curing agent for a polyurethane paint of the present invention is combined with a conventional base resin for a metal paint comprising a polyurethane, or a base resin comprising an acryl polyol having a relatively high glass transition temperature to produce a paint composition. The paint composition is a two-component paint composition in which a third component is not particularly added, and contributes to obtain a paint film having extensibility as well as being excellent in flexibility under low temperatures, water resistance, and weather resistance.

An aliphatic or alicyclic diisocyanate of the present invention may include, for example, tetramethylene diisocyanate, pentamethylene diisocyanate, hexamethylene diisocyanate, trimethylhexamethylene diisocyanate, lysine diisocyanate, isophorone diisocyanate, hydrogenated xylylene diisocyanate, 1,4-diisocyanatecyclohexane, and others.

Moreover, a polyol useful as a raw material of the curing agent for a polyurethane paint of the present invention is a copolymerized lactone polyol which is a copolymerized polyester produced by using different cyclic lactone compounds of not less than two members (species).

The number average molecular weight of the copolymerized lactone polyol in the present invention is preferably 500 to 3,000. In the case where the number average molecular weight is less than 500, the formed cured paint film is insufficient in mechanical strength, particularly flexibility or impact resistance under low temperatures, or gloss (luster) retention. In the case where the number average molecular weight is more than 3,000, the viscosities of the copolymerized lactone polyol as well as the obtained curing agent become high, resulting in deterioration of workability. In addition, the gloss retention of the cured paint film is deteriorated, and the hardness (e.g., pencil hardness) of the paint film lowers.

In the present invention, use of the different cyclic lactone compounds of not less than two members (species), compared with use of the single cyclic lactone compound, contributes to disturbance of the crystallinity of the obtained copolymerized lactone polyol. As a result, the viscosity of the copolymerized lactone polyol is estimated to be lowered even in the same molecular weight. Thus, lactone polyols having wide range of molecular weights are usable.

Incidentally, a polyester-series polyol or a polyether-series polyol is conventionally mainly used as a long chain polyol for a urethane prepolymer having hydroxyl groups in both terminals (ends). As the polyester-series polyol, there are generally used a polyester polyol obtained by a reaction of ethylene glycol, 1,4-butylene glycol, 1,6-hexane glycol (1,6-hexanediol), or others with adipic acid. However, if a cured paint film is formed with a paint composition which comprises a prepolymer synthesized from a polyester polyol with an aliphatic or alicyclic diisocyanate as a curing agent and an acryl polyol as a base resin, the cured paint film has a deficiency in water resistance or weather resistance. Moreover, as the polyether-series polyol, a homo- or copolymer of ethylene oxide or propylene oxide, or a polytetramethylene glycol which is a polymer of tetrahydrofuran is used. However, even if a cured paint film can be formed from the paint composition comprising the prepolymer synthesized from the polyether-series polyol and the aliphatic or alicyclic diisocyanate as the curing agent, such a cured paint film is easy to be oxidized and deteriorated due to the ether bond, and has disadvantages, for example, lack of weather resistance or heat resistance. Further, although other polyols include a polybutadiene-series polyol, a ricinus-containing polyol or others, a prepolymer synthesized from such a polyol and an aliphatic or alicyclic diisocyanate is insufficient in compatibility with an acryl polyol, and has a deficiency in weather resistance.

On the other hand, the copolymerized lactone polyol used in the present invention does not have the above deficiencies. Use of the copolymerized lactone polyol in combination with an aliphatic diisocyanate or alicyclic diisocyanate realizes a formation of a cured paint film excellent in not only mechanical properties but also gloss retention without deteriorating weather resistance and heat resistance. Such a cured paint film excellent in mechanical properties as well as gloss retention cannot be obtained from a polyether-series polyol.

Contrarily, in the case of using the lactone polyol obtained from a single cyclic lactone compound, the curing agent prepolymerized with the use of the lactone polyol has a problem that the curing agent becomes clouded due to crystallization of the lactone polyol. Further, in the cured paint film formed from an acryl polyol which employs the polyol, there causes a problem such as luster deterioration and decline of flexibility under low temperatures.

In the present invention, the number average molecular weight denotes a value determined based on the following formula:
Number average molecular weight=(56.11×N×1000)/hydroxyl value

wherein the hydroxyl value is a hydroxyl value of a copolymerized lactone polyol, and the hydroxyl value of the copolymerized lactone polyol is measured in accordance with the JIS K-1557 6.4.

The alphabet “N” is the number of active hydrogen groups in a low molecular weight compound which has at least two active hydrogen groups and is used as an initiator.

The copolymerized lactone polyol employed in the present invention is obtainable by ring-opening polymerization of a lactone compound such as E-caprolactone or δ-valerolactone in the presence of a low molecular weight compound having at least two active hydrogen groups as an initiator in the presence of a catalyst. The initiator has a molecular weight of not more than 1000, preferably not more than 500, and more preferably not more than 200, and for example, may include at least one member selected from the group consisting of a dihydric alcohol such as ethylene glycol, diethylene glycol, 1,3-butanediol, 1,4-butanediol, 1,5-pentanediol, 1,6-hexanediol, propylene glycol, or neopentyl glycol, a trihydric alcohol such as trimethylolpropane or glycerin, triethanolamine and pentaerythritol. In the case of increasing crosslinking density of the cured paint film, it is preferred to use an initiator having not less than three or more functional groups.

The catalyst may include an organic titanium-containing compound such as tetrabutyl titanate, tetrapropyl titanate, or tetraethyl titanate, a tin-containing compound such as stannum octanoate, dibutyl tin oxide, dibutyl tin dilaurate, stannous chloride, or stannous bromide. The ring opening polymerization of a lactone mixture is conducted under N₂ gas atmosphere, by adjusting the molar ratio of a mixture of cyclic lactone compounds such as ε-caprolactone and δ-valerolactone relative to the above initiator into a desired molecular weight, followed by adding 0.1 to 100 ppm of a catalyst relative to the cyclic lactone compound mixture on the basis of weight and reacting for 4 to 10 hours at a temperature of 150 to 200° C. to obtain a copolymerized lactone polyol.

The available cyclic lactone compound may include ε-caprolactone or δ-valerolactone, in addition trimethyl-ε-caproiactone, butylolactone, laurolactone, caprylolactone, and others. The most acquirable ε-caprolactone is usually employed in combination with a lactone compound (e.g., δ-valerolactone) other than ε-caprolactone.

The proportion of a first lactone compound relative to a second lactone compound is, in molar ratio, 15/85 to 85/10, preferably 20/80 to 80/20, and more preferably 30/70 to 70/30. If the proportion is out of the above range, the curing agent or the cured paint film becomes clouded, and deteriorated in paint film appearance, resulting in undesirable inclination. In addition to the first lactone compound and the second lactone compound, a small amount of a third lactone compound may be added.

The reaction of a copolymerized lactone polyol with an aliphatic diisocyanate or an alicyclic diisocyanate is conducted under the following conditions to produce a prepolymer as a curing agent for a polyurethane paint.

The reaction temperature is in a range of an ambient temperature (e.g., 20° C.) to200° C., and preferably 80 to 140° C. In the case where the reaction temperature is lower than 20° C., the longer time is required to complete the reaction. On the contrary, in the case where the reaction temperature excess 200° C., due to an undesirable side reaction, the viscosity of the generated prepolymer is increased, or heavy coloration is caused in the prepolymer. The reaction may be conducted without a solvent or may be conducted with an arbitrary solvent which is inactive to isocyanate group. Further, if necessary, a catalyst may be used for facilitating a reaction between isocyanate group and hydroxyl group.

Upon the reaction, the equivalent ratio of the diisocyanate relative to the copolymerized lactone polyol is important, and it is preferred to select the NCO/OH equivalent ratio of 5 to 20. In the case where the equivalent ratio is less than 5, a high molecular weight compound is generated because of successive addition polymerization between the diisocyanate and the copolymerized lactone polyol, resulting in undesirable increase of the viscosity of the prepolymer. Further, a prepolymer obtained under the condition of the NCO/OH equivalent ratio of less than 5 not only tends to show incompatibility with an acryl polyol as a base resin, but also adversely affects extensibility of the paint film. Moreover, in the case where the NCO/OH equivalent ratio is more than 20, long periods for removing an unreacted diisocyanate decrease productivity.

In the present invention, it is necessary to collect an unreacted diisocyanate in the reaction mixture after the completion of the reaction, by means of a device such as a thin film evaporator or a solvent extractor.

The unreacted diisocyanate is collected as much as possible, and the content of the unreacted diisocyanate is preferably not more than 0.7% by weight relative to the whole prepolymer. Remanence of the unreacted diisocyanate in the prepolymer beyond the above content causes troubles such as toxicity or acridity due to diisocyanate vapor.

The curing agent for a polyurethane paint of the present invention is a prepolymer, and is combined with a base resin of a polyurethane paint, preferably an acryl polyol(acrylic polymer). The paint film formed after curing not only has extensibility but also is excellent in flexibility under low temperatures, water resistance, and weather resistance.

The acryl polyol conventionally employed in the polyisocyanate curing acrylic urethane paints can be used as it is. The acryl polyol used in combination with the curing agent for a polyurethane paint (which is a prepolymer) of the present invention may be produced by a solution polymerization method usually in the presence an appropriate solvent by means of a device for producing an acrylic polymer equipped with a heating device, an agitating device, an injecting device, and others.

The typical examples of a radical polymerizable unsaturated monomer used in the production of the above acryl polyol are described as follows.

As a hydroxyl group-containing acrylic monomer, there may be mentioned 2-hydroxyethyl acrylate, 2-hydroxyethyl methacrylate, hydroxypropyl methacrylate, hydroxypropyl acrylate, and a lactone adduct thereof. An acryl polyol(acrylic polymer) can be obtained by radical copolymerizing at least one hydroxyl group-containing acrylic monomer mentioned above with at least one radical polymerizable unsaturated monomer mentioned below.

Among the radical polymerizable unsaturated monomers, examples of an ester of acrylic acid or methacrylic acid may include a C₁₋₁₃alkyl or cycloalkyl ester of acrylic acid or methacrylic acid, such as methyl acrylate, ethyl acrylate, propyl acrylate, isopropyl acrylate, butyl acrylate, hexyl acrylate, octyl acrylate, lauryl acrylate, cyclohexyl acrylate, methyl methacrylate, propyl methacrylate, isopropyl methacrylate, butyl methacrylate, hexyl methacrylate, octyl methacrylate, lauryl methacrylate, or cyclohexyl methacrylate; an alkoxyalkyl ester of acrylic acid or methacrylic acid such as methoxybutyl acrylate, methoxybutyl methacrylate, methoxyethyl acrylate, methoxyethyl methacrylate, ethoxybutyl acrylate, or ethoxybutyl methacrylate; an adduct of glycidyl acrylate or glycidyl methacrylate with a C₃₋₁₈monocarboxylic acid compound (e.g., acetic acid, propionic acid, oleic acid, stearic acid, lauric acid, and p-t-butylbenzoic acid), and adduct of “CARDURA E-10” (trade mark) with an unsaturated acid such as acrylic acid. A vinyl aromatic compound may include, for example, styrene, α-methylstyrene, vinyltoluene, p-chlorostyrene, vinylpyridine, and the like. Examples of α, β-ethylenic unsaturated carboxylic acid may include acrylic acid, methacrylic acid, crotonic acid, itaconic acid, maleic acid, maleic anhydride, fumaric acid, and others. Further, as a glycidyl group-containing vinyl-series monomer, there maybe exemplified glycidyl acrylate, glycidylmethacrylate, allyl glycidyl ether, and the like. An amide of acrylic acid or methacrylic acid may include, for example, acrylamide, N-methylolacrylamide, N-butoxymethylacrylamide, and others. An alkoxysilane-containing ethylenic unsaturated monomer may include, for example, 1-methacryloxytrimethoxysilane, and others.

In addition, acrylonitrile and methacrylonitrile may be included.

These radical polymerizable unsaturated monomers may be suitably selected depending on the desired physical properties of the resin, and may be used singly or in combination.

The copolymerization of the above hydroxyl group-containing acrylic monomer with the radical polymerizable unsaturated monomer may be conducted in accordance with the known method, for example, by a solution polymerization method. The polymerization can be performed generally by reacting at least two members of the above monomer components in the presence of a polymerization catalyst in an appropriate solvent usually at a reaction temperature of from 40 to 170° C. for 4 to 10 hours.

Moreover, examples of the polymerization catalyst may include an initiator used for an ordinary radical polymerization, such as an azo-series compound, a peroxide-series compound, a diazo compound, a redox series compound, and others.

The glass transition temperature (Tg) of thus obtained acryl polyol may be preferably in a range of 30 to 100° C. in consideration of using the acryl polyol as a regular repairing paint for automobiles.

Hereupon, the Tg of the acryl polyol is determined by the following formula with the use of Tg (° C.) of each homopolymer. The Tgs of major homopolymers are described in Polymer Handbook (2nd Edition, published by A Wiley Interscience).

$$Tg ( °C . ) = \frac{1}{\frac{WA}{TgA + 273} + \frac{WB}{TgB + 273} + …} - 273$$

WA, WB . . . : % by weight of a monomer A, a monomer B, . . . in the acryl polyol

TgA, TgB . . . : Tg (° C.) of a homopolymer of the monomer A, Tg (° C.) of a homopolymer of the monomer B, . . . .

In the case of using a monomer which does not give Tg of a homopolymer thereof in Polymer Handbook, the Tg of an acryl polyol is obtained by actual measurement with the dilatometry method.

Moreover, in the acryl polyol combined with a prepolymer as the curing agent for a polyurethane paint of the present invention, the hydroxyl value of the acryl polyol is preferably in a range of 10 to 150 (KOHmg/g) on the resin basis. In the case where the acryl polyol has a hydroxyl value of less than 10 on the resin basis, the acryl polyol undesirably affects solvent resistance of the paint film due to small crosslinking density in the paint film. Moreover, the acryl polyol having a hydroxyl value of more than 150 has an adverse effect on extensibility of the paint film.

Incidentally, the hydroxyl value can be measured in accordance with the JIS K-1557 6.4.

As the above acryl polyol, commercially available acryl polyols can be also employed. The commercially available acryl polyol may include “ACRYDICA-801”, “ACRYDIC A-802” [(trade name) manufactured by Dainippon Ink & Chemicals, Inc.], “HITALOID 3008”, “HITALOID 3083”[(trade name) manufactured by Hitachi Chemical Co., Ltd.], “COATAX LH-601”, “COATAXLH-603” [(trade name) manufactured by Toray Industries, Inc.], and others.

The paint film excellent in extensibility is obtainable by blending a prepolymer as the curing agent for a polyurethane paint of the present invention with the above-mentioned acryl polyol, applying the blended matter to a subject to be painted, and curing the applied matter. The blending ratio of the acryl polyol relative to the curing agent is, in terms of NCO/OH equivalent ratio, preferably 0.5 to 2.0. That is, the NCO/OH equivalent ratio of less than 0.5 lowers weather resistance or solvent resistance of the paint film. Contrarily, the NCO/OH equivalent ratio of more than 2.0 sometimes causes unsatisfactory results in terms of drying characteristics. Moreover, in necessary, there may be added a curing-acceleration catalyst such as triethylamine, tetra(2-ethylhexyl)titanate, ordi-n-butyl tin dilaurate.

### EXAMPLES

The following examples are intended to describe this invention in further detail and should by no means be interpreted as defining the scope of the invention.

### Production Example 1

Into a round bottom flask equipped with an agitator, a thermometer, a water separator and a nitrogen gas inlet, were charged 510 parts by weight of ε-caprolactone, 278 parts by weight of δ-valerolactone and 212 parts by weight of trimethylolpropane (TMP) as an initiator, ring opening copolymerization was conducted under nitrogen flow at 180° C. for 6 hours. After confirming that the total content of remaining two lactone compounds becomes not more than 2% by weight, the degree of vacuum was gradually enlarged by means of a vacuum pump for removing the remaining two members of lactone compounds until the content of the remaining lactone compounds decreased to not more than 1% by weight. Thus a liquid copolymerized lactone polyol was obtained, and the copolymerized lactone polyol had a hydroxyl value of 336.1 KOHmg/g, an acid value of 0.06 KOHmg/g, a water content of 0.005% by weight, a viscosity at 25° C. of 1120 mPa.s, and a number average molecular weight of 500.

### Production Examples 2 to 13

Copolymerized lactone polyols were obtained in the same manner with the Production Example 1 except that the charged amounts of ε-caprolactone, δ-valerolactone, and trimethylolpropane were changed in the value shown in the Tables 1 and 2. Moreover, the properties of the obtained copolymerized lactone polyols were also shown in the Tables 1 and 2.

TABLE 1

| | Production | Production | Production | Production | Production | Production | Production |
|---|---|---|---|---|---|---|---|
| | Example 1 | Example 2 | Example 3 | Example 4 | Example 5 | Example 6 | Example 7 |
| ε-Caprolactone | 510 | 548 | 587 | 609 | 463 | 712 | 193 |
| (CL) | | | | | | | |
| δ-Valerolactone | 278 | 320 | 342 | 355 | 405 | 156 | 675 |
| (VL) | | | | | | | |
| Initiator (TMP) | 212 | 133 | 71 | 35 | 133 | 133 | 133 |
| Number of | 3 | 3 | 3 | 3 | 3 | 3 | 3 |
| functional groups | | | | | | | |
| CL/VL molar ratio | 60/40 | 60/40 | 60/40 | 60/40 | 50/50 | 80/20 | 20/80 |
| Mn of copolymerized | 500 | 800 | 1500 | 3000 | 800 | 800 | 800 |
| lactone polyol | | | | | | | |
| OH value | 336.1 | 210.2 | 112.2 | 56.3 | 210.5 | 210.7 | 210.1 |
| Acid value | 0.06 | 0.08 | 0.05 | 0.06 | 0.07 | 0.07 | 0.05 |
| Water content | 0.005 | 0.005 | 0.004 | 0.006 | 0.08 | 0.06 | 0.08 |
| Viscosity | 1250 | 1330 | 1950 | 4450 | 1350 | 1370 | 1350 |
| (25° C., mPa · s) | | | | | | | |
| Appearance | liquid | liquid | liquid | liquid | liquid | liquid | liquid |

ATTN: The number of functional groups has the same meanings with the number of active hydrogen groups of the initiator in the present invention.

TABLE 2

| | Production | Production | Production | Production | Production | Production |
|---|---|---|---|---|---|---|
| | Example 8 | Example 9 | Example 10 | Example 11 | Example 12 | Example 13 |
| ε-Caprolactone | 790 | 98 | 630 | 476 | 697 | 875 |
| (CL) | | | | | | |
| δ-Valerolactone | 77 | 770 | 344 | 259 | — | — |
| (VL) | | | | | | |
| Initiator (TMP) | 133 | 133 | 27 | 265 | 303 | 125 |
| Number of | 3 | 3 | 3 | 3 | 3 | 3 |
| functional groups | | | | | | |
| CL/VL molar ratio | 90/10 | 10/90 | 60/40 | 60/40 | 100/0 | 100/0 |
| Mn of copolymerized | 800 | 800 | 4000 | 400 | 350 | 800 |
| lactone polyol | | | | | | |
| OH value | 210. 3 | 210.3 | 39.8 | 420.8 | 480.9 | 211.0 |
| Acid value | 0.07 | 0.06 | 0.08 | 0.08 | 0.05 | 0.06 |
| Water content | 0.06 | 0.005 | 0.004 | 0.005 | 0.004 | 0.006 |
| Viscosity | — | — | 7500 | 1330 | 1650 | — |
| (25° C., mPa · s) | | | | | | |
| Appearance | paste | paste | liquid | liquid | liquid | paste |

ATTN: The number of functional groups has the same meanings with the number of active hydrogen groups of the initiator in the present invention.

### Example 1

Into a round bottom flask equipped with an agitator, a thermometer, a water separator and a nitrogen gas inlet, were charged 883 g of hexamethylene diisocyanate (HMDI) and 117 g of copolymerized lactone polyol obtained in the production example 1, and the mixture was subjected to a reaction for 1 hour at 80° C. with agitating. The obtained reaction mixture was subjected to evaporation with a thin film evaporator for removing the unreacted HMDI in the condition that a wall temperature of the evaporator was 160° C. and a vacuum degree was 1 mmHg, and 220 g of a light yellowish transparent polyurethane curing agent was obtained. The NCO content of the curing agent was 12.2% by weight.

### Examples 2 to 7

Polyurethane curing agents were obtained in the same manner with the Example 1 except that the charged amounts of hexamethylene diisocyanate and the employed polyol were changed to the value shown in the Table 3. Moreover, the properties of the obtained curing agent were also shown in the Table 3.

### Comparative Examples 1 to 6

Polyurethane curing agents were obtained in the same manner with the Example 1 except that the charged amounts of hexamethylene diisocyanate and the employed polyol were changed to the value shown in the Table 4. Moreover, the properties of the obtained curing agent were also shown in the Table 4.

TABLE 3

| | Example 1 | Example 2 | Example 3 | Example 4 | Example 5 | Example 6 | Example 7 |
|---|---|---|---|---|---|---|---|
| Polyol used | Production | Production | Production | Production | Production | Production | Production |
| | Example 1 | Example 2 | Example 3 | Example 4 | Example 5 | Example 6 | Example 7 |
| Charged HMDI (g) | 883 | 825 | 716 | 371 | 825 | 826 | 825 |
| Charged Polyol (g) | 117 | 175 | 284 | 284 | 175 | 174 | 175 |
| NCO/OH equivalent | 15.0 | 15.0 | 15.0 | 15.0 | 15.0 | 15.0 | 15.0 |
| ratio | | | | | | | |
| Reaction | 80 | 80 | 80 | 80 | 80 | 80 | 80 |
| temperature (° C.) | | | | | | | |
| Reaction time (min) | 180 | 180 | 180 | 180 | 180 | 180 | 180 |
| Wall temp of thin | 160 | 160 | 160 | 160 | 160 | 160 | 160 |
| film evaporator | | | | | | | |
| (° C.) | | | | | | | |
| Evaporator | 1 | 1 | 1 | 1 | 1 | 1 | 1 |
| pressure (mmHg) | | | | | | | |
| Yield of curing | 211 | 256 | 342 | 464 | 259 | 253 | 260 |
| agent (g) | | | | | | | |
| NCO content in | 11.3 | 8.7 | 5.7 | 3.3 | 8.8 | 8.6 | 8.9 |
| curing agent | | | | | | | |
| (% by weight) | | | | | | | |
| Appearance of | transparent | transparent | transparent | transparent | transparent | transparent | transparent |
| curing agent | | | | | | | |
| Viscosity of curing | 4500 | 4600 | 8000 | 24000 | 4650 | 4680 | 4570 |
| agent (25° C., mPa · s) | | | | | | | |
| Free HMDI | <0.1 | <0.1 | <0.1 | <0.1 | <0.1 | <0.1 | <0.1 |
| (% by weight) | | | | | | | |

TABLE 4

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| Polyol used | Production | Production | Production | Production | Production | Production |
| | Example 8 | Example 9 | Example 10 | Example 11 | Example 12 | Example 13 |
| Charged HMDI (g) | 825 | 825 | 472 | 904 | 915 | 826 |
| Charged Polyol (g) | 175 | 175 | 528 | 96 | 85 | 174 |
| NCO/OH equivalent | 15.0 | 15.0 | 15.0 | 15.0 | 15.0 | 15.0 |
| ratio | | | | | | |
| Reaction | 80 | 80 | 80 | 80 | 80 | 80 |
| temperature (° C.) | | | | | | |
| Reaction time (min) | 180 | 180 | 180 | 180 | 180 | 180 |
| Wall temp of thin | 160 | 160 | 160 | 160 | 160 | 160 |
| film evaporator (° C.) | | | | | | |
| Evaporator | 1 | 1 | 1 | 1 | 1 | 1 |
| pressure (mmHg) | | | | | | |
| Yield of curing | 252 | 255 | 532 | 195 | 187 | 256 |
| agent (g) | | | | | | |
| NCO content in | 8.5 | 8.3 | 2.5 | 12.5 | 13.3 | 8.7 |
| curing agent | | | | | | |
| (% by weight) | | | | | | |
| Appearance of | clouded | clouded | transparent | transparent | transparent | clouded |
| curing agent | | | | | | |
| Viscosity of curing | 4850 | 4800 | 52000 | 5500 | 7700 | 4900 |
| agent (25° C., mPa · s) | | | | | | |
| Free HMDI | <0.1 | <0.1 | <0.1 | <0.1 | <0.1 | <0.1 |
| (% by weight) | | | | | | |

### Application Examples 1 to 7 and Reference Examples 1 to 6

Paint compositions were obtained by mixing each of a polyurethane curing agent prepared in Examples 1 to 7 and Comparative Examples 1 to 6, a diluent solvent (ethyl acetate:butyl acetate:toluene:xylene:cellosolve acetate=20:30:30:15:5% by weight), and an acrylpolyol (“ACRYDIC A-801”, OH value: 50 KOHmg/g, Tg: 70° C., manufactured by Dainippon Ink & Chemicals, Inc.) in the proportion shown in the Table 5.

Various comparative tests were conducted with the use of these paint compositions. The results are shown in the Tables 5 and 6, respectively.

TABLE 5

| | Application | Application | Application | Application | Application | Application | Application |
|---|---|---|---|---|---|---|---|
| | Example 1 | Example 2 | Example 3 | Example 4 | Example 5 | Example 6 | Example 7 |
| Corresponding | Example 1 | Example 2 | Example 3 | Example 4 | Example 5 | Example 6 | Example 7 |
| curing agent | | | | | | | |
| Curing agent (g) | 8. 3 | 10.8 | 16.4 | 28.4 | 10.6 | 10.9 | 10.5 |
| ACRYDIC A-801 (g) | 25 | 25 | 25 | 25 | 25 | 25 | 25 |
| NCO/OH equivalent | 1 | 1 | 1 | 1 | 1 | 1 | 1 |
| ratio | | | | | | | |
| Diluent | 8.3 | 10.8 | 16.4 | 28.4 | 10.6 | 10.9 | 10.5 |
| Compatibility with | good | good | good | good | good | good | good |
| acryl polyol¹⁾ | | | | | | | |
| Appearance of paint | transparent | transparent | transparent | transparent | transparent | transparent | transparent |
| film²⁾ | | | | | | | |
| Working life (hr)³⁾ | 32-46 | 32-46 | 50-64 | 45-58 | 32-46 | 32-46 | 32-46 |
| Pencil hardness⁴⁾ | 2B | 2B | 3B | 5B | 2B | 2B | 2B |
| Break extention (%)⁵⁾ | B | A | A | A | A | A | A |
| Break strength | A | A | A | A | A | A | A |
| (MPas)⁶⁾ | | | | | | | |
| Flexibility under | B | A | A | A | A | A | A |
| low temperatures⁷⁾ | | | | | | | |
| Impact resistance | A | A | A | A | A | A | A |
| under low | | | | | | | |
| temperatures⁸⁾ | | | | | | | |
| Gloss retention⁹⁾ | A | A | A | A | A | A | A |

TABLE 6

| | Reference | Reference | Reference | Reference | Reference | Reference |
|---|---|---|---|---|---|---|
| | Example 1 | Example 2 | Example 3 | Example 4 | Example 5 | Example 6 |
| Corresponding | Comparative | Comparative | Comparative | Comparative | Comparative | Comparative |
| curing agent | Example 1 | Example 2 | Example 3 | Example 4 | Example 5 | Example 6 |
| Curing agent (g) | 11. 0 | 11.3 | 37.4 | 7.5 | 7.0 | 10.8 |
| ACRYDIC A-801 (g) | 25 | 25 | 25 | 25 | 25 | 25 |
| NCO/OH equivalent | 1 | 1 | 1 | 1 | 1 | 1 |
| ratio | | | | | | |
| Diluent | 11.0 | 11.3 | 37.4 | 7.5 | 7.0 | 10.8 |
| Compatibility with | good | good | bad | good | good | good |
| acryl polyol¹⁾ | | | | | | |
| Appearance of paint | a little | a little | clouded | transparent | transparent | a little |
| film²⁾ | clouded | clouded | | | | clouded |
| Working life (hr)³⁾ | 32-46 | 32-46 | >500 | 24-36 | 24-36 | 32-46 |
| Pencil hardness⁴⁾ | 2B | 2B | >6B | H | H | 2B |
| Break extention | A | A | A | C | C | A |
| (%)⁵⁾ | | | | | | |
| Break strength | A | A | C | A | A | A |
| (MPas)⁶⁾ | | | | | | |
| Flexibility under | B | B | A | C | C | B |
| low temperatures⁷⁾ | | | | | | |
| Impact resistance | B | B | A | C | C | B |
| under low | | | | | | |
| temperatures⁸⁾ | | | | | | |
| Gloss retention⁹⁾ | C | C | C | A | A | C |

1) Compatibility of acryl polyol: visually evaluated.
2) Appearance of paint film (clearpaint film, film thickness of 50 μm): visually evaluated.
3) Working life: gelation time at 20° C., under 65% RH.
4) Pencil hardness: in accordance with JIS K6400, 6.14 (substrate: steel sheet, 20° C.×7 days after).
5) Break extension: in accordance with JIS K6301, A: >50%, B: 10 to 50%, C: <10%
6) Break strength (MPa.s): in accordance with JIS K6301, A: >2000, B: 1000 to 2000, C: <1000
7) Flexibility under low temperatures: ½ inch mandrel (−30° C.), JIS K5400 6.16 (substrate: commercially available automobile bumper, thickness: 3 mm),

A: excellent, B: good, C: crack generation
8) Impact resistance under low temperatures: Du Point Impact test (−30° C.) ½ inch×500 g×500 mm (substrate: commercially available automobile bumper, thickness: 3 mm),

A: excellent, B: good, C: crack generation
9) Gloss retention: Sunshine weather meter, measured in accordance with JIS K28741 after exposure to a temperature of 63±3° C. and a rainfall of 12 minutes/60 minutes×100 hours,

A: >80%, B: 50 to 80%, C: <50%

### INDUSTRIAL APPLICABILITY

The present invention can provide a curing agent for a two-component polyurethane paint which is capable of forming a cured paint film having a high mechanical strength, in particular, having a high flexibility or impact resistance under low temperatures and excellent in gloss (luster) retention. The above excellent properties are never achieved in the cured paint film formed from the conventional two-component polyurethane paint with the use of a lactone polyol obtained from single cyclic lactone compound.

1. A process for producing a curing agent for a polyurethane paint, which comprises allowing an aliphatic or alicyclic diisocyanate to react with a polyester polyol having at least two active hydrogen groups in a molecule thereof in an NCO/OH equivalent ratio of 5 to 20, and removing an unreacted aliphatic or alicyclic diisocyanate, wherein the polyester polyol is a copolymerized lactone polyol obtained by a ring-opening copolymerization of at least two members of cyclic lactone compounds each represented by the following formula (I) in the presence of a low molecular weight compound having at least two active hydrogen groups as an initiator 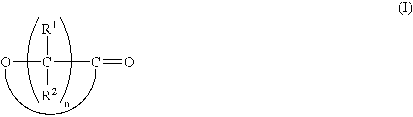
wherein R¹ and R² may be the same or different, each representing a hydrogen atom or a C₁₋₄alkyl group, and 3≦n≦7.

2. A process according to claim 1, wherein the cyclic lactone compounds represented by the formula (I) comprise ε-caprolactone and δ-valerolactone, and the molar ratio of the ε-caprolactone relative to the δ-valerolactone being 80/20 to 20/80.

3. A process according to claim 1, wherein the number average molecular weight of the copolymerized lactone polyol is 500 to 3000.

4. A process according to claims 1, wherein the initiator comprises at least one member selected from the group consisting of ethylene glycol, diethylene glycol, 1,4-butanediol, 1,5-pentanediol, 1,6-hexanediol, neopentyl glycol, glycerin, trimethylolpropane, triethanolamine, and pentaerythritol.

5. A curing agent for a polyurethane paint obtainable by a production process recited in claim 1.
